(19) United States
(12) Patent Application Publication
(10) Pub. No.: US 2006/0197675 A1
(43) Pub. Date: Sep. 7, 2006

(54) Remote control interface framework using an infrared module and a method thereof

(75) Inventor: Ming-Feng Liu, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Compal Electronics, Inc.

(21) Appl. No.: 11/175,749

(22) Filed: Jul. 6, 2005

(30) Foreign Application Priority Data
Mar. 4, 2005 (TW) 94106718

(51) Int. Cl. H04B 10/00

(52) U.S. Cl. 340/825.69; 398/107

(57) ABSTRACT

A remote control interface framework using an infrared module in a portable electronic apparatus for controlling the electronic apparatus and a method thereof are described. The framework has an infrared module, an input/output (I/O) unit, an I/O control unit, an embedded controller and an operating system executed in the electronic apparatus. In data transmission mode, data received by the infrared module are transmitted to the I/O unit. In remote control mode, a control signal received by the infrared module is converted into a control code by the embedded controller, and then the control code is carried out by the operating system or the I/O control unit for a corresponding control operation.

### RELATED APPLICATIONS

The present application is based on, and claims priority from, Taiwan Application Serial Number 94106718, filed Mar. 4, 2005, the disclosure of which is hereby incorporated by reference herein in its entirety.

### BACKGROUND

1. Field of Invention

The present invention relates to an interface framework and a method for remotely controlling a portable electronic apparatus. More particularly, the present invention relates to a remote control interface framework using an infrared module and a method thereof.

2. Description of Related Art

Following the development and the progress of the manufacturing techniques of electronic and information product, an electronic product is usually needed to communicate with other electronic product. Hence, a general information processing system, such as a personal computer (PC), a laptop, a personal digital assistant (PDA) or a mobile phone, may have an interface used to transmit and receive data with other system, in which the interface may be an infrared module interface.

The infrared module is a short-distance directional wireless signal communication apparatus, and the major purpose thereof is to be a data communication medium between two systems. The infrared module becomes a basic component in many kinds of portable electronic information processing system nowadays, such as laptop and mobile phone, due the several advantages thereof. For example, the communication basis of the infrared module is simple, and the volume and the cost of the infrared module are small and low.

For increasing the functions of the infrared module in the portable electronic apparatus, the infrared module nowadays may be designed to be a wireless control signal receiving device allowing remote control of the portable electronic apparatus or the peripheral of the portable electronic apparatus via a control signal. For example, if the infrared module on a laptop is able to receive a control signal, then a user can remotely control the laptop and the peripheral of the laptop as when controlling a television set via a remote control.

A related implementation is mentioned in a Taiwan Patent No. 480840. As FIG. 1 shows, an electronic apparatus 100 has a conventional serial port 104, a infrared module 108 and a chip set 102 used to control the serial port 104 and infrared module 108. In general, the infrared module 106 is merely treated as a data communication device by the chip set 102. Thus, if the signal transmitted from an external signal source to the infrared module 106 is a data signal, it will be received and processed by the chip set 102. If the signal is a control signal, it will not be received and processed by the chip set 102.

The serial port 104 has both functions of data communication and the controlling interface; hence, the chip set 102 will receive and process the signal received by the serial port 102 whether the signal is a data signal or a control signal. Therefore, the purpose of wireless controlling is implemented by combining the characteristics of the infrared module 102 and the serial port 104 in this invention, that is, the wireless communication ability of the infrared module and the ability for receiving and controlling control signal of the serial port 104.

A switch circuit 108 shown in FIG. 1 is a medium for connecting the serial port 104 and the infrared port 106. When the infrared is used to carry out a general communication of data signal, the switch circuit 108 is disabled, and both the infrared module 106 and the serial port 104 are kept in a state of general operation. When the infrared is used as a receiving interface for a control signal, the switch circuit 108 is enabled, and a control signal received from the infrared module 106 will be transmitted to the serial port 104. Thus, the control signal can be treated as a control signal received from the serial port 104 and further processed by the chip set 102, and the function of wireless remote control can be obtained.

The above device does have some problems. For example, the volume and the cost of the system will be increased by adding the switch circuit 108 because the switch circuit 108 is an additional component. In addition, because the above wireless controlling interface is implemented by combining the infrared module 106 and the serial port 104, the acceptable control signal standard and the signal receiving rate of the interface are limited by the serial port 104, and the flexibility in design is further limited.

### SUMMARY

It is therefore an objective of the present invention to provide an infrared controlling interface framework used in a portable electronic apparatus.

It is another objective of the present invention to provide an infrared controlling interface framework used in a portable electronic apparatus with low cost and small volume.

It is still another objective of the present invention to provide an infrared controlling interface framework used in a portable electronic apparatus with flexibility in design.

It is another objective of the present invention to provide an infrared controlling interface framework used in a portable electronic apparatus to allow remote control of the portable electronic apparatus.

According to the foregoing objectives of the invention, the infrared controlling interface according to the first embodiment of the present invention includes an infrared module, an input/output (I/O) unit, an embedded controller, an I/O control unit and an operating system executed in the electronic apparatus. When an external signal is received by the infrared module, the signal will be transmitted to both the I/O unit and the embedded controller. At this time, if the signal is a data signal, the embedded controller will have no response, and the I/O unit will be controlled by the I/O control unit to convert the data signal into data and then transmit the data to the operating system for storage. If the signal is a control signal, the I/O unit will have no response. The control signal will be converted into a control code by the embedded controller and then transmitted to the operating system or the I/O control unit to carry out the corresponding control operation.

The infrared controlling interface according to the second embodiment of the present invention includes an infrared module, an I/O unit, an embedded controller, an I/O control unit, an input device and an operating system executed in the electronic apparatus. When an external signal is received by the infrared module, the signal will be transmitted to both the I/O unit and the embedded controller. At this time, if an enable signal has been stored in the embedded controller by the input device, the signal will be treated as a control signal and converted into a control code by the embedded controller, and then the control code is transmitted to the operating system for the corresponding control operation. If the enable signal has not been stored in the embedded controller, the signal will be treated as a data signal and transmitted to the I/O control unit to be converted into data. The data is then transmitted to the operating system for storage. Thus, an infrared module has two functions of data transmission and control interface.

### BRIEF DESCRIPTION OF THE DRAWINGS

These and other features, aspects and advantages of the present invention will become better understood with regard to the following description, appended claims and accompanying drawings where:

FIG. 1 is a framework diagram of a conventional a remote control interface using an infrared module;

FIG. 2 is a framework diagram of a remote control interface according to the first embodiment of the present invention;

FIG. 3 is a flow chart of a remote control method according to the first embodiment of the present invention;

FIG. 4 is a framework diagram of a remote control interface according to the second embodiment of the present invention; and

FIG. 5 is a flow chart of a remote control method according to the second embodiment of the present invention;

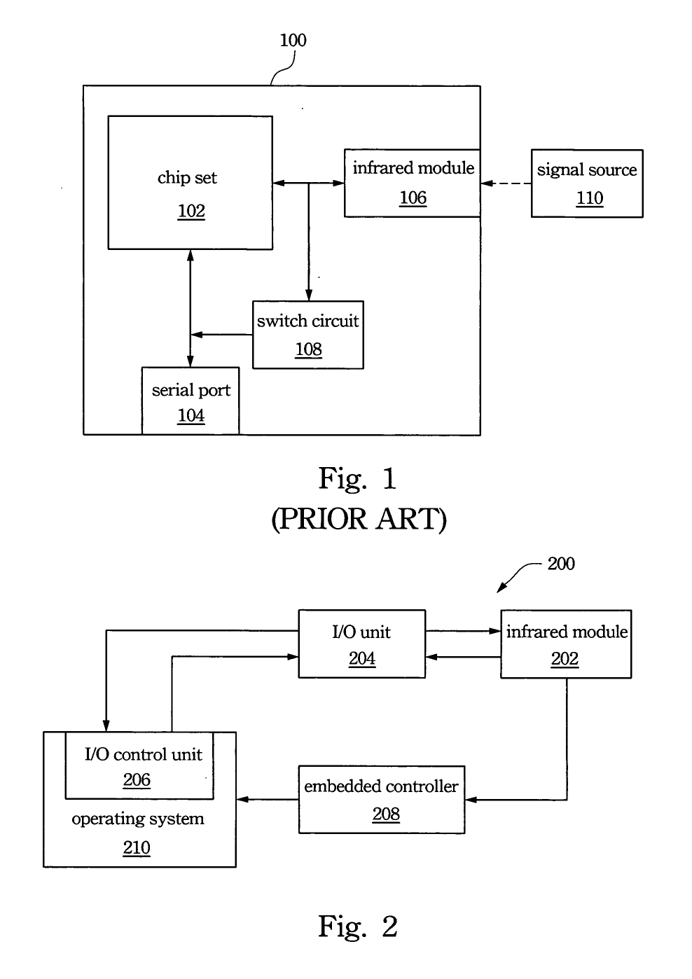

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The basic concept of the present invention is to use the infrared data transmission module on a portable electronic apparatus as a remote control interface, which is able to control the portable electronic apparatus. For this goal, the arrangement of some circuit components and the functions of the embedded controller in the portable electronic apparatus need to be redefined.

FIG. 2 shows a diagram of a circuit framework 200 according to the first embodiment of the present invention. The circuit framework 200 may be a part of an electronic apparatus such as a laptop, and it includes an infrared module 202, an input/output (I/O) unit 204, an embedded controller 208 and an operating system 210 executed in the electronic apparatus. The operating system includes an I/O control unit 206. The foregoing components may be implemented by the infrared module, I/O unit (e.g. a super I/O interface integrating a print port, RS-232 port, a keyboard port and a mouse port), I/O control unit, embedded controller and operating system used in a conventional electronic apparatus.

In the first embodiment of the present invention, the embedded controller 208 and the I/O control unit 206 are able to determine whether a signal inputted into the circuit framework 200 is a data signal or a control signal. Hence, the infrared module 202 used to receive the remote signal, which is a data signal or a control signal, is connected to both the I/O unit 204 and the embedded controller 208. When the signal is received by the infrared module 202, it will be transmitted to both the I/O unit 204 and the embedded controller 208 at once.

Both the I/O unit 204 and the embedded controller 208 will receive the signal transmitted from the infrared module 202. In the first embodiment of the present invention, if the signal is a data signal, it will be processed by the I/O unit 204. If the signal is a control signal, it will be processed by the embedded controller 208. Because the formats of a data signal and a control signal are different, when the signal transmitted from the infrared module 202 is received by the embedded controller 208, the embedded controller 208 will determine whether the signal is a control signal at once. When the signal transmitted from the infrared module 202 is received by the I/O unit 204, the I/O unit 204 will transmit the signal to the I/O control unit 206 in the operating system 210, and then the I/O control unit 210 immediately determines whether the signal is a data signal.

If the signal is a data signal, the I/O unit 204 will accept the data signal and the embedded controller 208 will discard the data signal. Then, the data signal is transmitted to the I/O control unit 206 in the operating system 210 and data will be fetched from the data signal by the I/O control unit 206. Finally, the data is transmitted by the I/O control unit 206 to the operating system 210 for subsequent processes, such as storage or computing. Hence, both the I/O unit 204 and the embedded controller 208 are connected to the operating system 210 and the I/O unit 204 is connected to the I/O control unit 206.

Generally, the I/O control unit 206 may be a driver in the operating system 210, which is used to determine whether the signal is a data signal, and then convert the data signal into data allowing the operating system 210 to carry out a data processing operation. According to the design of the system, the I/O control unit 206 may be separated from the operating system 210 in practice.

Similarly, when a data is desired to be transmitted to an other electronic apparatus from the operating system 210 via the infrared module 202, the operating system 210 will notify the I/O control unit 206. The I/O control unit 206 enables the I/O unit 204 and converts the data into a data signal. The data signal is then received by the I/O unit 204. Next, the data signal is transmitted from the I/O unit 204 to the infrared module 202 and then transmitted to the other electronic apparatus by the infrared module 202.

The operation of data transmission is discussed in the foregoing description. It can be seen that the data transmission function of the infrared module 202 is still reserved and is not influenced by the following control interface function.

Continuing the foregoing discussion, if the signal received by the infrared module 202 is a control signal, the embedded controller 208 will accept the control signal and the I/O unit 204 will discard the control signal by the control of the I/O control unit 206. The embedded controller 208 then converts the control signal into a control code, which can be accepted by the operating system 210, such as the scan code used by a keyboard module. The control code will be transmitted to the operating system 210, and then the operating system 210 can carry out a control operation corresponding to the control code for controlling the electronic apparatus itself or a peripheral thereof.

In addition, because some components in the electronic apparatus or some peripherals of the electronic apparatus may be controlled by the embedded controller 208, the control operation corresponding to the control code can be also carried out by the embedded controller 208 to control these components or peripherals.

In the first embodiment of the present invention, the embedded controller 208 in the circuit framework 200 may be modified from an embedded controller, which may be used to control a keyboard, touch pad or power system in a conventional electronic apparatus such as, for example, a laptop. Two more functions, determining and converting a control signal, are added to the embedded controller 208, and the two functions may be added by redesigning or programming the embedded controller 208.

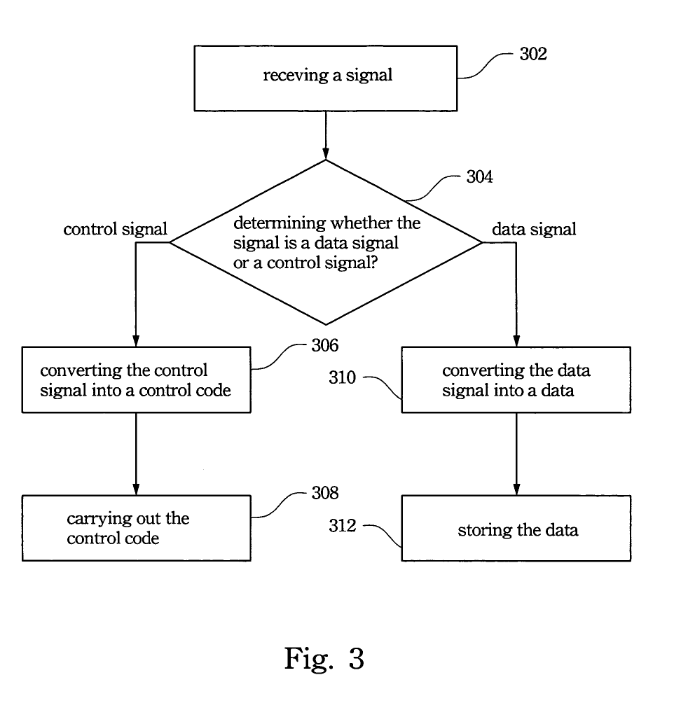

FIG. 3 shows a flow chart of the method according to the first embodiment of the present invention. In step 302, a remote signal is received by an infrared module of an electronic apparatus. In step 304, whether the signal is a data signal or a control signal is determined. If the signal is a control signal, the control signal is converted by an embedded controller into a control code, such as a scan code used by the keyboard module, and then the control code is transmitted to an operating system in step 306. In step 308, a control operation corresponding to the control code is carried out by the operating system for controlling the electronic apparatus itself or a peripheral thereof. If it is determined that the signal is a data signal in step 304, the data signal is transmitted to an I/O control unit via the infrared module and an I/O unit. In step 310, the data signal is converted into data by the I/O control unit. In step 312, the data is stored by the operating system.

In addition, when the operating system detects that the signal being received by the infrared module is a control signal, the operating system can use the basic input/output system (BIOS) of the electronic apparatus to disable the function of signal receiving of the I/O unit for preventing interference with the infrared module when receiving the control signal.

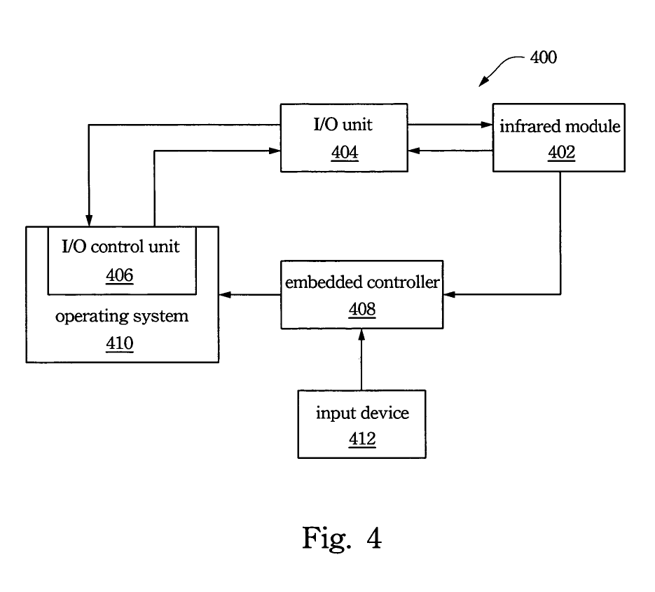

FIG. 4 shows a diagram of a circuit framework 400 according to the second embodiment of the present invention. The circuit framework 400 may be a part of an electronic apparatus such as a laptop, and it includes an infrared module 402, an input/output (I/O) unit 404, an embedded controller 408, an input device 412 and an operating system 410 executed in the electronic apparatus. The operating system includes an I/O control unit 406. The foregoing components may be implemented by the infrared module, I/O unit (e.g. a super I/O interface integrating a print port, RS-232 port, a keyboard port and a mouse port), I/O control unit, embedded controller, and operating system used in a conventional electronic apparatus.

In the second embodiment of the present invention, whether an enable signal has been stored in the embedded controller 408 is determined by the embedded controller 408 at first, and then how to process a signal received by the infrared module 402 can be determined. Hence, the infrared module 402 used to receive the remote signal, which may be a data signal or a control signal, is connected to both the I/O unit 404 and the embedded controller 408. When the signal is received by the infrared module 402, it will be transmitted to both the I/O unit 404 and the embedded controller 408 at once.

Both the I/O unit 404 and the embedded controller 408 will receive the signal transmitted from the infrared module 402. In the second embodiment of the present invention, whether an enable signal has been stored in the embedded controller 408 is determined by the embedded controller. The enable signal may be inputted into the embedded controller 408 via a hot key of an input device 412, such as a keyboard module, and the connection between the embedded controller 408 and the input device 412 may be wired or wireless. If the enable signal has been stored in the embedded controller 408, the signal will be treated as a control signal, and then is converted into a control code acceptable for the operating system 410, such a scan code used in the keyboard module of a personal computer system. Then, the operating system 410 can carry out a control operation corresponding to the control code for controlling the electronic apparatus itself and a peripheral thereof.

In addition, because some components in the electronic apparatus or some peripherals of the electronic apparatus may be controlled by the embedded controller 408, the control operation corresponding to the control code can be also carried out by the embedded controller 408 to control these components or peripherals.

Continuing the foregoing discussion, if the enable signal have not be stored in the embedded controller 408, the embedded controller will notify the operating system 410 that the signal received by the infrared module should be treated as a data signal, and then the I/O control unit 406 in the operating system 410 is enabled. At this time, the signal is transmitted to the I/O control unit 406 via the infrared module 408 and the I/O unit 404, and then data are fetched from the data signal by the I/O control unit 406. Finally, the data are transmitted by the I/O control unit 406 to the operating system 410 for subsequent processes, such as storing or computing. Hence, both the I/O unit 404 and the embedded controller 408 are connected to the operating system 410 and the I/O unit 404 is connected to the I/O control unit 406.

Generally, the I/O control unit 406 may be a driver in the operating system 410, which is used to determine whether the signal is a data signal, and then convert the data signal into data so the operating system 410 can carry out a data processing operation. According to the design of the system, the I/O control unit 406 may be separated from the operating system 410 in practice.

Similarly, when data needs to be transmitted to other electronic apparatus from the operating system 410 via the infrared module 402, the operating system 410 will notify the I/O control unit 406 to allow the I/O control unit 406 to enable the I/O unit 404 and convert the data into a data signal. The data signal is then received by the I/O unit 204. Next, the data signal is transmitted from the I/O unit 404 to the infrared module 402 and then transmitted to the other electronic apparatus by the infrared module 402.

In the second embodiment of the present invention, the embedded controller 408 in the circuit framework 400 may be modified from an embedded controller, which may be used to control a keyboard, touch pad or power system in a conventional electronic apparatus such as a laptop. Two more functions are added the embedded controller 408, that is, the functions of determining and converting a control signal. The two functions may be added by redesigning or programming the embedded controller 408.

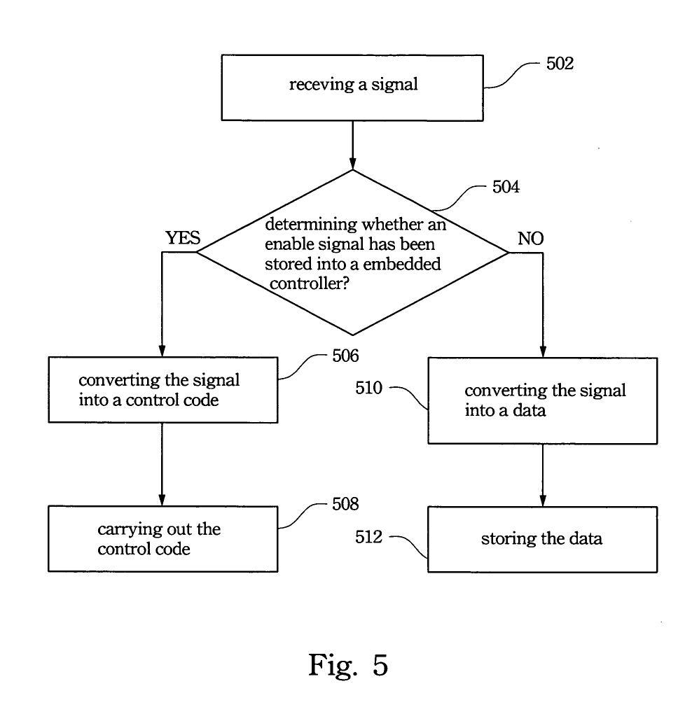

FIG. 5 shows a flow chart of the method according to the second embodiment of the present invention. In step 502, a remote signal is received by an infrared module of an electronic apparatus. In step 504, whether an enable signal has been stored in an embedded controller is determined. If the enable signal has been stored in the embedded controller, the signal is treated as a control signal and converted by the embedded controller into a control code, such as a scan code used by the keyboard module, and then the control code is transmitted to an operating system in step 506. In step 508, a control operation corresponding to the control code is carried out by the operating system for controlling the electronic apparatus itself or a peripheral thereof. If it is determined that the enable signal has not been stored in the embedded controller in step 504, the signal is treated as a data signal. In step 510, the data signal is converted into data by an I/O control unit. In step 512, the data are transmitted to the operating system and then stored by the operating system.

In addition, when the enable signal has been stored in the embedded controller, the operating system can use the basic input/output system (BIOS) of the electronic apparatus to disable the function of signal receiving of the I/O unit for preventing interference with the infrared module when receiving the control signal.

It will-be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A remote control interface used in an electronic apparatus, comprising:
an infrared module used to receive and transmit a data signal or a control signal;
an input/output (I/O) unit used to transmit the data signal or the control signal, wherein said I/O unit is connected with said infrared module;
an I/O control unit used to convert the data signal and data into each other, wherein said I/O unit is connected with said I/O unit;
an embedded controller used to convert the control signal into a control code, wherein said embedded controller is connected with said infrared module; and
an operating system used to receive the data to carry out a data processing operation or receive the control code to carry out a control operation, wherein said operating system is connected with said I/O control unit and said embedded controller.

2. The remote control interface of claim 1, wherein said I/O unit is a super I/O unit.

3. The remote control interface of claim 1, wherein the control code is able to control said electronic apparatus.

4. The remote control interface of claim 1, wherein said electronic apparatus is connected with a peripheral device and said peripheral device is controlled by said operating system and the control code.

5. The remote control interface of claim 1, wherein said embedded controller is connected with an input device and said input device is able to input an enable signal into said embedded controller.

6. The remote control interface of claim 5, wherein whether a signal received by said embedded controller is the data signal or the control signal is determined by said embedded controller according to the condition of the enable signal.

7. The remote control interface of claim 1, wherein said embedded controller is able to receive the data signal and the control signal.

8. The remote control interface of claim 7, wherein said embedded controller is able to determine whether a signal received by said embedded controller is the data signal or the control signal.

9. The remote control interface of claim 1, wherein said I/O control unit is able to receive the data signal and the control signal.

10. The remote control interface of claim 9, wherein said I/O control unit is able to determine whether a signal received by said I/O control unit is the data signal or the control signal.

11. The remote control interface of claim 1, wherein the control code is a scan code used in the keyboard module of said electronic apparatus.

12. A method for implementing a remote control interface using an infrared module in an electronic apparatus, comprising:
(a) using said infrared module to receive a signal;
(b) transmitting the signal to an input/output (I/O) unit and an embedded controller;
(c) using an I/O control unit connected with said I/O unit and said embedded controller to determine whether the signal is a data signal or a control signal, wherein if the signal is the data signal, step (d) to step (e) are carried out, and if the signal is the control signal, step (f) to step (g) are carried out;
(d) using said embedded controller to convert the control signal into a control code;
(e) using said operating system to carry out the control code to control said electronic apparatus and then ending said method;
(f) using said I/O control unit to convert the data signal into data; and
(g) using said operating system to store the data and then ending said method.

13. The method of claim 12, further comprising a step of stopping the data transmission between said infrared module and said electronic apparatus before step (d).

14. The method of claim 12, wherein said I/O unit is a super I/O unit.

15. The method of claim 12, wherein the control code is able to control said electronic apparatus.

16. The method of claim 12, wherein said electronic apparatus is connected with a peripheral device and said peripheral device can be controlled by said operating system and the control code.

17. The method of claim 12, wherein the control code is a scan code used in the keyboard module of said electronic apparatus.

18. A method for implementing a remote control interface using an infrared module in a electronic apparatus, comprising:
(a) using said infrared module to receive a signal;
(b) transmitting the signal to an input/output (I/O) unit and an embedded controller;
(c) using said embedded controller to determine whether an enable signal has been stored in said embedded controller, wherein if the enable signal has been stored in said embedded controller, step (d) to step (e) are carried out, and if the enable signal has not been stored in said embedded controller, step (f) to step (g) are carried out;
(d) using said embedded controller to convert the control signal into a control code;
(e) using said operating system to carry out the control code to control said electronic apparatus and then ending said method;
(f) using said I/O control unit to convert the data signal into data; and
(g) using said operating system to store the data and then ending said method.

19. The method of claim 18, wherein said I/O unit is a super I/O unit.

20. The method of claim 18, wherein the control code is able to control said electronic apparatus.

21. The method of claim 18, wherein said electronic apparatus is connected with a peripheral device and said peripheral is controlled by said operating system and the control code.

22. The method of claim 18, wherein the control code is a scan code used in a keyboard module of said electronic apparatus.

23. The method of claim 18, further comprising a step of using said operating system to stop said I/O control unit from processing a data signal after step (d).
